(19) United States
(12) Patent Application Publication
(10) Pub. No.: US 2012/0195180 A1
(43) Pub. Date: Aug. 2, 2012

(54) OPTICAL PICKUP APPARATUS

(75) Inventors: Yuki KOSHIMIZU, Kashiwa-shi (JP); Mitsuru ITO, Zama-shi (JP); Hiroyuki ICHIKAWA, Hanno-shi (JP)

(73) Assignees: SANYO OPTEC DESIGN CO., LTD., Gunma-ken (JP); SANYO ELECTRIC CO., LTD., Osaka (JP)

(21) Appl. No.: 13/358,842

(22) Filed: Jan. 26, 2012

(30) Foreign Application Priority Data
Jan. 27, 2011 (JP) 2011-014764

(51) Int. Cl. G11B 7/135

(52) U.S. Cl. 369/112.18; G9B/7.112

(57) ABSTRACT

An optical-pickup apparatus includes: a single-wavelength-laser diode to emit a first-laser beam; a two-wavelength-laser diode to emit second- and third-laser beams; an objective lens; a photodetector to be irradiated with first- to third-reflected-light beams of the first- to third-laser beams reflected from the signal-recording layers of first- to third-optical discs; an aberration-correcting plate to guide the second- and third-laser beams toward the lens, and correct astigmatism of the reflected-light beams, and guide the astigmatism-corrected-reflected-light beams toward the photodetector; a semitransparent mirror to guide, toward the lens, the first-laser beam and the second- and third-laser beams having been guided by the aberration-correcting plate, and guide the reflected-light beams toward the aberration-correcting plate; a quarter-wave plate to convert the first- to third-laser beams from linearly-polarized light into circularly-polarized light, and convert the reflected-light beams from circularly-polarized light into linearly-polarized light; and a divergent lens to correct aberration caused by the mirror.

### CROSS-REFERENCE TO RELATED APPLICATION

This application claims the benefit of priority to Japanese Patent Application No. 2011-14764, filed Jan. 27, 2011, of which full contents are incorporated herein by reference.

### BACKGROUND OF THE INVENTION

1. Field of the Invention

The present invention relates to an optical pickup apparatus configured to execute an operation of reading signals recorded in an optical disc and an operation of recoding signals in an optical disc, using a laser beam.

2. Description of the Related Art

An optical disc apparatus is widely available that is capable of executing operations of reading signals and recording signals by irradiating a signal recording layer of an optical disc with a laser beam emitted from an optical pickup apparatus.

Optical disc apparatuses, which use optical discs referred to as “CD” and “DVD”, are commonly available as the optical disc apparatus, however, optical disc apparatuses have recently been developed, which use optical discs whose recording densities are improved, that is, optical discs of Blu-ray standard.

Infrared light having a wavelength of 785 nm is used as a laser beam to execute the operation of reading signals recorded in the optical disc of CD standard. Red light having a wavelength of 655 nm is used as a laser beam to execute the operation of reading signals recorded in the optical disc of DVD standard.

The optical disc of CD standard is provided with a transparent protective layer having a thickness of 1.2 mm between the signal recording layer and the surface of the optical disc, and the numerical aperture of an objective lens is set at 0.47 that is used to execute the operation of reading signals from the signal recording layer. The optical disc of DVD standard is provided with a transparent protective layer having a thickness of 0.6 mm between the signal recording layer and the surface of the optical disc, and the numerical aperture of an objective lens is set at 0.6 that is used to execute the operation of reading signals from the signal recording layer.

As opposed to the laser beams used for the optical discs of the CD standard and the DVD standard, a laser beam having a short wavelength, such as blue-violet light having a wavelength of 405 nm, for example, is used as the laser beam to execute the operation of reading signals recorded in the optical disc of Blu-ray standard.

The optical disc of Blu-ray standard is provided with a protective layer having a thickness of 0.1 mm on the top face of a signal recording layer thereof, and the numerical aperture of an objective lens is set at 0.85 that is used to execute the operation of reading signals from the signal recording layer.

It is required to reduce the diameter of a laser spot which is formed by condensing a laser beam in order to execute the operations of reading signals recorded on the signal recording layer provided in the optical disc of Blu-ray standard and recording signals on the signal recording layer. An objective lens to be used to acquire a desired laser spot shape is characterized by not only its large numerical aperture but also its short focal length resulting in its small curvature radius.

An optical disc apparatus has been commercialized which is capable of executing operations of reading signals recorded in all the above described optical discs of CD standard, DVD standard, and Blu-ray standard and recording signals therein, while the following optical pickup apparatus is commonly employed as an optical pickup apparatus incorporated in an optical disc apparatus, which includes: a laser diode configured to emit a first laser beam to execute an operation of reading signals recorded in an optical disc of Blu-ray standard; a first objective lens configured to condense the first laser beam emitted from the laser diode onto a signal recording layer; a two-wavelength laser diode configured to emit a second laser beam to execute the operation of reading signals recorded in an optical disc of DVD standard and a third laser beam to execute the operation of reading signals recorded in an optical disc of CD standard; and a second objective lens configured to condense the second and third laser beams onto the signal recording layer of each of the optical discs (see Japanese Laid-Open Patent Publication No. 2010-61781).

Further, there has recently been developed a technique of being able to condense a first laser beam, a second laser beam, and a third laser beam on signal recording layers provided in optical discs of standard different from one another, using one objective lens (see, e.g., Japanese Laid-Open Patent publication No. 2006-236414).

In an optical pickup apparatus configured to execute operations of reading signals recorded in three types of optical discs of different standards from each other, using a laser diode configured to emit a laser beam having one wavelength; a two-wavelength laser diode configured to emit two laser beams having two wavelengths; and two objective lenses or a single objective lens, such a problem is caused that a large number of optical components are necessary when optical paths are provided for the laser beams, respectively, resulting in the apparatus not only being expensive but also being unable to be downsized.

As described in Japanese Laid-Open Patent Publication No. 2010-61781, a technique has been provided of commonly using the optical path as well as commonly using a photodetector, as a method of solving such a problem. Such a technique, however, has a problem of increasing the cost of manufacturing since two polarizing beam splitters are used as optical elements to combine optical paths.

As a method of solving such a problem, commonality of optical paths is provided among first, second, and third laser beams, using a single polarizing beam splitter and a single semitransparent mirror. An optical pickup apparatus configured as such will be described with reference to FIGS. 2 and 3.

In FIG. 3, reference numeral 1 denotes a laser diode configured to generate and emit the first laser beam that is blue-violet light having a wavelength of 405 nm, for example. Reference numeral 2 denotes a first diffraction grating, on which the first laser beam emitted from the laser diode 1 is incident, and which includes: a diffraction grating unit 2a configured to split the laser beam into a main beam, which is 0-order light, and two sub-beams, which are +1st order light and −1st order light; and a half-wave plate 2b configured to convert an incident laser beam into light linearly polarized in the S-direction.

Reference numeral 3 denotes a two-wavelength laser diode, in which a first laser element configured to generate and emit a second laser beam that is red light having a wavelength of 655 nm, for example, and a second laser element configured to generate and emit a third laser beam that is infrared light having a wavelength of 785 nm, for example, are accommodated in the same casing.

Reference numeral 4 denotes a second diffraction grating, on which the second and third laser beams respectively emitted from the first and second laser elements incorporated in the two-wavelength laser diode 3 are incident, and which includes: a diffraction grating unit 4a configured to split the laser beam into a main beam that is 0-order light and two sub beams that are +1st order light and −1st order light; and a half-wave plate 4b configured to convert an incident laser beam into light linearly polarized in the S-direction.

Reference numeral 5 denotes a divergence lens provided at a position on which the second and third laser beams emitted from the two-wavelength laser diode 3 are incident through the second diffraction grating 4, and the divergence lens 5 has a function of adjusting a divergence angle of a laser beam that is diverging light incident thereon.

Reference numeral 6 denotes a semitransparent mirror configured to reflect the S-polarized light of the first laser beam that is incident thereon after passing through the first diffraction grating 2, and allows P-polarized light to pass therethrough that is return light (reflected light beams) of the first, second, and third laser beams reflected from the optical discs following optical paths which will be described later. Reference numeral 7 denotes a polarizing beam splitter configured to reflect the S-polarized light of the second and third laser beams incident thereon through the second diffraction grating 4 and the divergence lens 5, pass the incident first laser beam therethrough after being reflected by the semitransparent mirror 6, and pass therethrough the P-polarized light that is return light of the first, second, and third laser beams reflected from the optical discs.

The polarizing beam splitter 7 configured as such is also configured to partially pass therethrough the S-polarized light of the second and third laser beams incident thereon through the second diffraction grating 4 and the divergence lens 5, and partially reflect the S-polarized light of the incident first laser beam after being reflected from the semitransparent mirror 6.

Reference numeral 8 denotes a three-wavelength-compatible quarter-wave plate that is provided at a position, on which the first laser beam having passed through the polarizing beam splitter 7 and the second and third laser beams reflected by the polarizing beam splitter 7 are incident; and that has a function of converting the laser beams incident thereon corresponding to the laser beams having three different wavelengths from linearly polarized light into circularly polarized light, and in an opposite manner, from circularly polarized light into linearly polarized light.

Reference numeral 9 denotes a collimating lens, on which the laser beams having passed through the quarter-wave plate 8 are incident, and which converts the laser beams incident thereon into parallel light, and the collimating lens 9 is configured to correct spherical aberration that is caused based on the thickness of the protective layer of each of the optical discs by an operation of moving in a direction of the optical axis of the collimating lens 9.

Reference numeral 10 denotes a first objective lens configured to condense the first laser beam onto a signal recording layer L1 provided in a first optical disc D1 (see FIG. 2). Reference numeral 11 denotes a second objective lens configured to condense the second laser beam onto a signal recording layer L2 provided in a second optical disc D2, and condense the third laser beam onto a signal recording layer L3 provided in a third optical disc D3. In such a configuration, the first and second objective lenses 10 and 11 are mounted on a member called lens holder, which is supported so as to be able to execute an operation of moving in a focusing direction that is perpendicular to the face of the optical disc and an operation of moving in a tracking direction that is the radial direction of the optical disc, using four supporting wires, for example.

A configuration is such that the first, second, and third laser beams having passed through the collimating lens 9 are guided to the first and second objective lenses 10 and 11 by an optical system depicted in FIG. 2. In FIG. 2, reference numeral 12 denotes a wavelength selective element and the wavelength selective element 12 is configured to pass the first laser beam therethrough and reflect the second and third laser beams toward the second objective lens 11. Reference numeral 13 denotes a reflecting mirror configured to reflect the first laser beam having passed through the wavelength selective element 12 toward the first objective lens 10.

In such a configuration, the first laser beam having passed through the collimating lens 9 passes through the wavelength selective element 12, is reflected by the reflecting mirror 13, and is incident on the first objective lens 10. The first laser beam incident on the first objective lens 10 as such is condensed onto the signal recording layer L1 provided in the first optical disc D1 by a condensing operation of the first objective lens 10.

The second laser beam having passed through the collimating lens 9 is reflected by the wavelength selective element 12 and is incident on the second objective lens 11. The second laser beam incident on the second objective lens 11 as such is condensed onto the signal recording layer L2 provided in the second optical disc D2 by a condensing operation of the second objective lens 11. The third laser beam having passed through the collimating lens 9 is reflected by the wavelength selective element 12 and is incident on the second objective lens 11. The third laser beam incident on the second objective lens 11 as such is condensed onto the signal recording layer L3 provided in the third optical disc D3 by the condensing operation of the second objective lens 11.

In such a configuration, the first laser beam emitted from the laser diode 1 is incident on the first objective lens 10 through the first diffraction grating 2, the semitransparent mirror 6, the polarizing beam splitter 7, the quarter-wave plate 8, the collimating lens 9, the wavelength selective element 12, and the reflecting mirror 13. Thereafter, the first laser beam is applied, as an irradiation spot, onto the signal recording layer L1 provided in the first optical disc D1 by the condensing operation of the first objective lens 10, and the first laser beam applied to the signal recording layer L1 is reflected as return light by the signal recording layer L1.

The second laser beam emitted from the first laser element of the two-wavelength laser diode 3 is incident on the second objective lens 11 through the second diffraction grating 4, the divergence lens 5, the polarizing beam splitter 7, the quarter-wave plate 8, the collimating lens 9, and the wavelength selective element 12. Thereafter, the second laser beam is applied, as an irradiation spot, onto the signal recording layer L2 provided in the second optical disc D2 by the condensing operation of the second objective lens 11, and the second laser beam applied to the signal recording layer L2 is reflected as return light by the signal recording layer L2.

The third laser beam emitted from the second laser element of the two-wavelength laser diode 3 is incident on the second objective lens 11 through the second diffraction grating 4, the divergence lens 5, the polarizing beam splitter 7, the quarter-wave plate 8, the collimating lens 9, and the wavelength selective element 12. Thereafter, the third laser beam is applied, as an irradiation spot, onto the signal recording layer L3 provided in the third optical disc D3 by the condensing operation of the second objective lens 11, and the third laser beam applied to the signal recording layer L3 is reflected as return light by the signal recording layer L3.

The return light of the first laser beam reflected from the signal recording layer L1 of the first optical disc D1 is incident on the semitransparent mirror 6 through the first objective lens 10, the reflecting mirror 13, the wavelength selective element 12, the collimating lens 9, the quarter-wave plate 8, and the polarizing beam splitter 7. The return light incident on the semitransparent mirror 6 as such has been changed into light linearly polarized in the P direction by a phase shift operation executed by the quarter-wave plate 8. Therefore, such return light of the first laser beam passes through the semitransparent mirror 6, as a control laser beam, without being reflected by the semitransparent mirror 6.

The return light of the second laser beam reflected from the signal recording layer L2 of the second optical disc D2 is incident on the semitransparent mirror 6 through the second objective lens 11, the wavelength selective element 12, the collimating lens 9, the quarter-wave plate 8, and the polarizing beam splitter 7. The return light incident on the semitransparent mirror 6 as such is changed into light linearly polarized in the P direction by the phase shift operation executed by the quarter-wave plate 8. Therefore, such return light of the second laser beam passes through the semitransparent mirror 6, as a control laser beam, without being reflected by the semitransparent mirror 6.

The return light of the third laser beam reflected from the signal recording layer L3 of the third optical disc D3 is incident on the semitransparent mirror 6 through the second objective lens 11, the wavelength selective element 12, the collimating lens 9, the quarter-wave plate 8, and the polarizing beam splitter 7. The return light incident on the semitransparent mirror 6 as such is changed into light linearly polarized in the P direction by the phase shift operation executed by the quarter-wave plate 8. Therefore, such return light of the third laser beam passes through the semitransparent mirror 6, as a control laser beam, without being reflected by the semitransparent mirror 6.

Reference numeral 14 denotes an aberration correcting plate that is referred to as “as plate” where a control laser beam having been passed through the semitransparent mirror 6 is incident thereon, and has a function of enlarging the magnitude of astigmatism caused by the semitransparent mirror 6 to the magnitude suitable for producing a focus error signal as well as a function of setting the direction in which the astigmatism is produced, and another function of correcting coma aberration caused by the semitransparent mirror 6. Reference numeral 15 denotes a three-wavelength-compatible photodetector, which is irradiated with the control laser beam through the aberration correcting plate 14, is provided with a known four-split sensor, etc., and is configured to execute: a focusing error signal producing operation to execute a signal producing operation, which is associated with the operation of reading signals recorded on the signal recording layer of the optical disc, and a focusing control operation using an astigmatism method, by an irradiation operation of the main beam; and a tracking error signal producing operation to execute a tracking control operation by irradiation operations of the two sub beams.

As described above, comparing the outward path to the signal recording layer L1 of the first optical disc D1 of the first laser beam emitted from the laser diode 1; the outward path to the signal recording layer L2 of the second optical disc D2 of the second laser beam emitted from the two-wavelength laser diode 3; and the outward path to the signal recording layer L3 of the third optical disc D3 of the third laser beam emitted from the two-wavelength laser diode 3, it can be understood that an optical path from the polarizing beam splitter 7 to the wavelength selective element 12 is common to these outward paths.

Comparing the return path to the photodetector 15 of the return light of the first laser beam reflected from the signal recording layer L1 of the first optical disc D1; the return path to the photodetector 15 of the return light of the second laser beam reflected from the signal recording layer L2 of the second optical disc D2, and the return path to the photodetector 15 of the return light of the third laser beam reflected from the signal recording layer L3 of the third optical disc D3, it can be understood that an optical path from the wavelength selective element 12 to the photodetector 15 is common to these return paths.

In the optical pickup apparatus depicted in FIG. 3, the polarizing beam-splitter 7 is used as an optical component that combines optical paths to serve both as an outward path guiding laser beams having different wavelengths to signal recording layers of optical discs; and a return path guiding return light reflected from the signal recording layers of the optical discs to a photodetector 15, thereby causing such a problem that the apparatus becomes expensive.

### SUMMARY OF THE INVENTION

An optical pickup apparatus according to an aspect of the present invention, includes: a single-wavelength laser diode configured to emit a first laser beam having a first wavelength to read a signal recorded in a first optical disc having a signal recording layer at a first distance from a surface thereof; a two-wavelength laser diode configured to emit a second laser beam having a second wavelength, longer than the first wavelength, to read a signal recorded in a second optical disc having a signal recording layer at a second distance from a surface thereof, and a third laser beam having a third wavelength, longer than the second wavelength, to read a signal recorded in a third optical disc having a signal recording layer at a third distance from a surface thereof, the second distance being longer than the first distance, the third distance being longer than the second distance; an objective lens configured to condense the first laser beam onto the signal recording layer of the first optical disc, the second laser beam onto the signal recording layer of the second optical disc, and the third laser beam onto the signal recording layer of the third optical disc; a photodetector configured to be irradiated with first reflected light beam of the first laser beam reflected from the signal recording layer of the first optical disc, second reflected light beam of the second laser beam reflected from the signal recording layer of the second optical disc, and third reflected light beam of the third laser beam reflected from the signal recording layer of the third optical disc; an aberration correcting plate disposed on an optical path between the objective lens and the photodetector, the aberration correcting plate configured to guide the second and the third laser beams toward the objective lens, and correct astigmatism of the first to the third reflected light beams, and guide the first to the third reflected light beams with astigmatism corrected toward the photodetector; a semitransparent mirror disposed on an optical path between the aberration correcting plate and the objective lens, the semitransparent mirror configured to guide, toward the objective lens, the first laser beam, and the second and the third laser beams having been guided by the aberration correcting plate, and guide the first to the third reflected light beams toward the aberration correcting plate; a quarter-wave plate disposed on an optical path between the semitransparent mirror and the objective lens, the quarter-wave plate configured to convert the first to the third laser beams from linearly polarized light into circularly polarized light, and convert the first to the third reflected light beams from circularly polarized light into linearly polarized light; and a divergent lens disposed on an optical path between the two-wavelength laser diode and the aberration correcting plate, the divergent lens configured to correct aberration caused by the semitransparent mirror.

### BRIEF DESCRIPTION OF THE DRAWINGS

For more thorough understanding of the present invention and advantages thereof, the following description should be read in conjunction with the accompanying drawings, in which:

FIG. 1 is a schematic diagram illustrating an embodiment of an optical pickup apparatus according to the present invention;

FIG. 2 is a diagram illustrating a portion of an embodiment of an optical pickup apparatus according to the present invention; and

FIG. 3 is a schematic diagram illustrating an embodiment of an optical pickup apparatus.

### DETAILED DESCRIPTION OF THE INVENTION

At least the following details will become apparent from descriptions of this specification and of the accompanying drawings.

An optical pickup apparatus according to an embodiment of the present invention incorporates therein: a laser diode configured to emit a first laser beam having a first wavelength to execute an operation of reading a signal recorded in a first optical disc in which a distance from a surface of the optical disc to a signal recording layer thereof is short; and a two-wavelength laser diode configured to emit two laser beams, i.e., a laser beam having a second wavelength to execute an operation of reading a signal recorded in a second optical disc in which a distance from a surface of the optical disc to a signal recording layer thereof is longer than that of the first optical disc, and a laser beam having a third wavelength to execute an operation of reading a signal recorded in a third optical disc in which a distance from a surface of the optical disc to a signal recording layer thereof is longer than that of the second optical disc. The optical pickup apparatus includes: an aberration correcting plate that reflects, toward an objective lens, the second and the third laser beams emitted from the two-wavelength laser diode as well as allows the first laser beam, the second laser beam, and the third laser beam which are reflected from the signal recording layer of the first optical disc, the signal recording layer of the second optical disc, and the signal recording layer of the third optical disc to pass therethrough toward a photodetector; a semitransparent mirror that is disposed between the aberration correcting plate and the objective lens, that guides the first laser beam emitted from the laser diode, the second laser beam and the third laser beam reflected by the aberration correcting plate toward the objective lens, and that guides the first laser beam, the second laser beam, and the third laser beam reflected from the signal recording layer of the first optical disc, the signal recording layer of the second optical disc, and the signal recording layer of the third optical disc toward the aberration correcting plate; and a divergent lens that has an aberration correcting function of correcting aberration caused by the semitransparent mirror between the two-wavelength laser diode and the aberration correcting plate.

The optical pickup apparatus according to an embodiment of the present invention includes a three-wavelength-compatible collimating lens in an optical path between the semitransparent mirror and the objective lens, and corrects spherical aberration using an operation of moving the collimating lens in a direction of an optical axis.

According to an embodiment of the present invention, in the optical pickup apparatus that is configured to execute operations of reading the signals recorded on the signal recording layers by condensing the first, the second, and the third laser beams having wavelengths different from one another on the signal recording layers provided in the first, the second, and the third optical discs of standards different from one another, the semitransparent mirror is used as an optical component that combines optical paths, thereby being able to reduce a manufacturing cost thereof as compared to a case of using a prism-type polarizing beam splitter.

According to an embodiment of the present invention, not only the semitransparent mirror is used as optical path combining means but also the divergent lens having the aberration correcting function is used to cancel astigmatism caused by the semitransparent mirror, thereby being able to simplify optical composition thereof.

In an embodiment of the present invention, a description will, hereinafter, be given of an optical pickup apparatus configured to execute operations of reading signals recorded on signal recording layers provided in optical discs of different standards using laser beams emitted from a laser diode that generates one single laser beam and a two-wavelength laser diode that generates two laser beams having wavelengths different from each other.

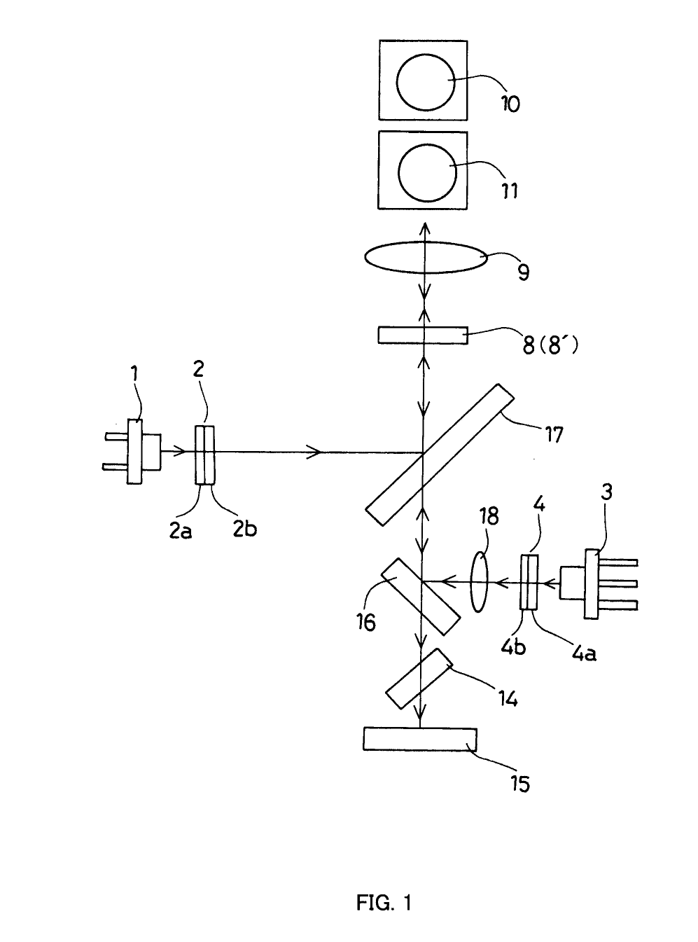

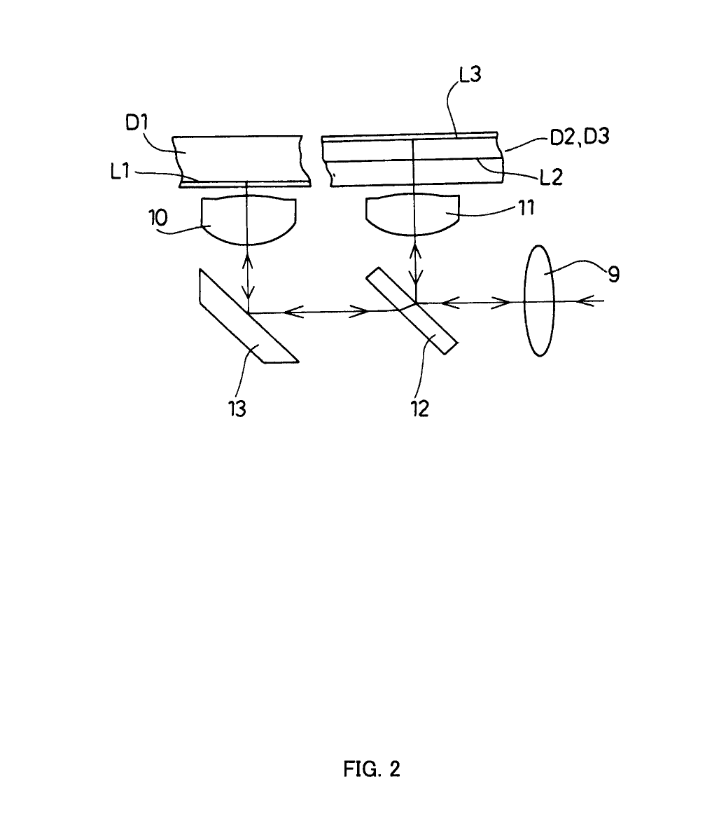

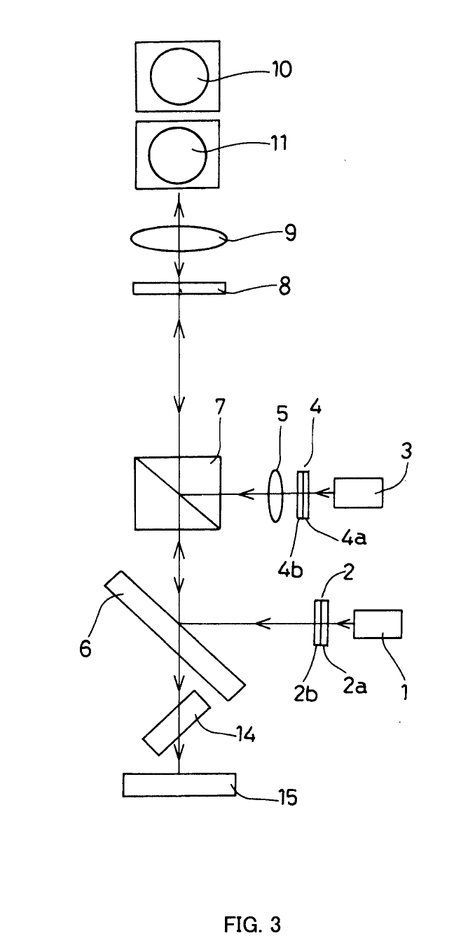

FIG. 1 depicts an embodiment according to an optical pickup apparatus of the present invention, and a description thereof will be described with reference to FIGS. 1 and 2. Here, components having the same functions as those in the pickup apparatus depicted in FIG. 3 are given the same reference numerals. In an embodiment of the present invention, a so-called three-wavelength-compatible wideband wave plate respectively compatible with wavelengths of the first to the third laser beams is employed as a quarter-wave plate 8 of FIG. 1, similarly to the quarter-wave plate 8 depicted in FIG. 3, however, it is not limited thereto. For example, in place of the above described quarter-wave plate 8, a quarter-wave plate 8′ may be employed that is configured to convert the first laser beam from linearly polarized light into circularly polarized light having a wavelength of 405 nm of the first laser beam, which is the shortest wavelength imposing the most stringent recording and reproducing conditions, or a wavelength around the wavelength. In this case, the second and the third laser beams are converted by the quarter-wave plate 8′ from linearly polarized light into circularly polarized light. However, a structural design of the quarter-wave plate 8′ is required to be such that the second and the third laser beams is converted into circularly polarized light to an extent to which operations of recording signals into the second and the third optical discs D2 and D3 and operations of reproducing signals recorded in the second and the third optical discs D2 and D3 are not disturbed.

Reference numeral 16 denotes an aberration correcting plate on which the second and the third laser beams emitted from the two-wavelength laser diode 3 are incident through the second diffraction grating 4, which is configured to reflect the second and the third laser beams toward the objective lens, and which is configured to correct astigmatism, etc., added to a control laser beam applied to the photodetector 15. A configuration thereof is such that S-polarized light is reflected therefrom and P-polarized light is allowed to pass therethrough.

Reference numeral 17 denotes a semitransparent mirror on which the first laser beam emitted from the laser diode 1 is incident through the first diffraction grating 2, which is configured to reflect the first laser beam toward the objective lens, and which is configured to allow the second laser beam and the third laser beam reflected by the aberration correcting plate 16 toward the objective lens. A configuration thereof is such that return light of the first, the second, and the third laser beams reflected from the optical discs is allowed to pass therethrough toward the photodetector 15.

Reference numeral 18 denotes a divergent lens that is disposed between the second diffraction grating 4, which allows the second laser beam and the third laser beam emitted from the two-wavelength laser diode 3 to pass therethrough, and the aberration correcting plate 16, and that is configured to have the aberration correcting function. The divergent lens 18 is design so as to have a function of correcting the astigmatism and the coma aberration caused by the semitransparent mirror 17 by canceling them, in addition to a function of adjusting divergent angles of the second and the third laser beams.

In the above configuration, a configuration is such that the astigmatism and the coma aberration caused when the second and the third laser beams pass through the semitransparent mirror 17 are canceled out by the aberration caused when these laser beams pass through the divergent lens 18. That is, the divergent lens 18 only has to be optically designed such that astigmatism is caused in a direction opposite to that in which the astigmatism is caused by the semitransparent mirror 17. The divergent lens 18 with the aberration correcting function is provided in the optical paths of the second and the third laser beams, thereby being able to cancel astigmatism. Thus, the aberration can be removed that is included in the second and the third laser beams incident on a second objective lens 11. Therefore, an optical pickup apparatus can be provided that is capable of executing operations of reading the signals recorded in the second optical disc and the third optical disc in a favorable manner.

In such a configuration, the first laser beam produced to be emitted from the laser diode 1 is guided to a first objective lens 10 through the first diffraction grating 2, the semitransparent mirror 17, the quarter-wave plate 8, a collimating lens 9, a wavelength selective element 12, and a reflecting mirror 13, and is condensed onto a signal recording layer L1 of the first optical disc D1 by a condensing operation of the first objective lens 10.

The return light of the first laser beam reflected from the signal recording layer L1 of the first optical disc D1 is applied to the photodetector 15 through the first objective lens 10, the reflecting mirror 13, the wavelength selective element 12, the collimating lens 9, the quarter-wave plate 8, the semitransparent mirror 17, the aberration correcting plate 16, and the as plate 14.

As such, executed are the operations of condensing the first laser beam emitted from the laser diode 1 on the signal recording layer L1 of the first optical disc D1 and of applying the return light reflected from the signal recording layer L1 to the photodetector 15, thereby being able to execute the operation of reading a signal recorded in the signal recording layer L1 of the first optical disc D1 through executions of a focus control operation, a tracking control operation, etc.

The second laser beam emitted from the two-wavelength laser diode 3: is guided to the second objective lens 11 through the second diffraction grating 4, the divergent lens 18, the aberration correcting plate 16, the semitransparent mirror 17, the quarter-wave plate 8, the collimating lens 9, and the wavelength selective element 12, and is condensed onto the signal recording layer L2 of the second optical disc D2 by the condensing operation of the second objective lens 11.

The return light of the second laser beam reflected from the signal recording layer L2 of the second optical disc D2 is applied to the photodetector 15 through the second objective lens 11, the wavelength selective element 12, the collimating lens 9, the quarter-wave plate 8, the semitransparent mirror 17, the aberration correcting plate 16, and the as plate 14.

As such, executed are the operations of condensing the second laser beam emitted from the two-wavelength laser diode 3 on the signal recording layer L2 of the second optical disc D2 and of applying the return light reflected from the signal recording layer L2 to the photodetector 15, thereby being able to execute the operation of reading a signal recorded in the signal recording layer L2 of the second optical disc D2 through the executions of the focus control operation, the tracking control operation, etc.

The third laser beam emitted from the two-wavelength laser diode 3 is guided to the second objective lens 11 through the second diffraction grating 4, the aberration correcting plate 16, the semitransparent mirror 17, the quarter-wave plate 8, the collimating lens 9, and the wavelength selective element 12, and is condensed onto the signal recording layer L3 of the third optical disc D3 by the condensing operation of the second objective lens 11.

The return light of the third laser beam reflected from the signal recording layer L3 of the third optical disc D3 is applied to the photodetector 15 through the second objective lens 11, the wavelength selective element 12, the collimating lens 9, the quarter-wave plate 8, the semitransparent mirror 17, the aberration correcting plate 16, and the as plate 14.

As such, executed are the operations of condensing the third laser beam emitted from the two-wavelength laser diode 3 on the signal recording layer L3 of the third optical disc D3 and of applying the return light reflected from the signal recording layer L3 to the photodetector 15, thereby being able to execute the operation of reading a signal recorded in the signal recording layer L3 of the third optical disc D3 through execution of the focus control operation, the tracking control operation, etc.

As described above, the astigmatism and the coma aberration of the second and the third laser beams caused by the semitransparent mirror 17 are canceled through the aberration correcting function retained by the divergent lens 18, thereby being able to acquire a function as an optical pickup apparatus of reading signals recorded in the optical discs with an inexpensive configuration.

As described above, executed are operations of condensing the laser beams on the signal recording layers L1, L2, and L3 provided in the first, the second, and the third optical discs D1, D2, and D3. However, a configuration is such that an operation of correcting spherical aberration, caused by a difference in thickness of a transparent protective layer, etc., provided between the signal recording layer and the incident surface of each of the optical discs, is executed through displacement of the collimating lens 9 in the direction of the optical axis using a rotating operation of a motor, etc.

The spherical aberration can be corrected through such a displacing operation of the collimating lens 9, thereby being able to improve signal reading characteristics of the optical pickup apparatus that is configured to combine the optical paths.

The above embodiments of the present invention are simply for facilitating the understanding of the present invention and are not in any way to be construed as limiting the present invention. The present invention may variously be changed or altered without departing from its spirit and encompass equivalents thereof.

A description has been given of a case of implementation in an optical pickup apparatus that executes operations of reading signals recorded in the optical discs of CD standard, DVD standard, and Blu-ray standard, however, implementation can be carried out also in an optical pickup apparatus capable of executing an operation of reading a signal recorded in an optical disc of another standard different from the above.

Further, in an embodiment of the present invention, a description is given of a case where implementation is carried out in an optical pickup apparatus including two objective lenses. However, implementation can be carried out also in an optical pickup apparatus that is configured to condense three laser beams on signal recording layers provided in optical discs using one objective lens, as described in Japanese Laid-Open Patent publication No. 2006-236414. In an optical pickup apparatus that is configured to condense three laser beams on signal recording layers provided in the optical discs using one objective lens, an angle of the return light applied to the photodetector, to the photodetector is able to be set to an angle suitable for producing a focus error signal, without using the as plate and an anamorphic lens. Therefore, the optical pickup apparatus has an advantage that the optical configuration thereof can be simplified.

What is claimed is:

1. An optical pickup apparatus comprising:
a single-wavelength laser diode configured to emit a first laser beam having a first wavelength to read a signal recorded in a first optical disc having a signal recording layer at a first distance from a surface thereof;
a two-wavelength laser diode configured to emit a second laser beam having a second wavelength, longer than the first wavelength, to read a signal recorded in a second optical disc having a signal recording layer at a second distance from a surface thereof, and a third laser beam having a third wavelength, longer than the second wavelength, to read a signal recorded in a third optical disc having a signal recording layer at a third distance from a surface thereof, the second distance being longer than the first distance, the third distance being longer than the second distance;
an objective lens configured to condense the first laser beam onto the signal recording layer of the first optical disc, the second laser beam onto the signal recording layer of the second optical disc, and the third laser beam onto the signal recording layer of the third optical disc;
a photodetector configured to be irradiated with first reflected light beam of the first laser beam reflected from the signal recording layer of the first optical disc, second reflected light beam of the second laser beam reflected from the signal recording layer of the second optical disc, and third reflected light beam of the third laser beam reflected from the signal recording layer of the third optical disc;
an aberration correcting plate disposed on an optical path between the objective lens and the photodetector, the aberration correcting plate configured to guide the second and the third laser beams toward the objective lens, and correct astigmatism of the first to the third reflected light beams, and guide the first to the third reflected light beams with astigmatism corrected toward the photodetector;
a semitransparent mirror disposed on an optical path between the aberration correcting plate and the objective lens, the semitransparent mirror configured to guide, toward the objective lens, the first laser beam, and the second and the third laser beams having been guided by the aberration correcting plate, and guide the first to the third reflected light beams toward the aberration correcting plate;
a quarter-wave plate disposed on an optical path between the semitransparent mirror and the objective lens, the quarter-wave plate configured to convert the first to the third laser beams from linearly polarized light into circularly polarized light, and convert the first to the third reflected light beams from circularly polarized light into linearly polarized light; and
a divergent lens disposed on an optical path between the two-wavelength laser diode and the aberration correcting plate, the divergent lens configured to correct aberration caused by the semitransparent mirror.

2. The optical pickup apparatus of claim 1, further comprising
a three-wavelength-compatible collimating lens disposed on an optical path between the semitransparent mirror and the objective lens, the three-wavelength-compatible collimating lens configured to move along a direction of an optical axis so as to correct spherical aberration.

3. The optical pickup apparatus of claim 1, wherein
the aberration correcting plate is configured to reflect the second and the third laser beams toward the semitransparent mirror, and allow the first to the third reflected light beams to pass therethrough toward the photodetector, and wherein
the semitransparent mirror is configured to reflect the first laser beam toward the objective lens, allow the second and the third laser beams having been reflected by the aberration correcting plate to pass therethrough toward the objective lens, and allow the first to the third reflected light beams to pass therethrough toward the aberration correcting plate.
